(19) United States
(12) Patent Application Publication
(10) Pub. No.: US 2010/0089985 A1
(43) Pub. Date: Apr. 15, 2010

(54) Envelopes with recordable and pre-recorded sound

(76) Inventor: Kelli Fusaro, Reading, PA (US)

Correspondence Address: Frank J. Bonini, Jr., P.O. Box 750, Valley Forge, PA, 19482-0750, US

(21) Appl. No.: 12/386,138

(22) Filed: Apr. 14, 2009

Related U.S. Application Data
(63) Continuation of application No. 29/310,748, filed on Oct. 14, 2008, now abandoned.

(51) Int. Cl. B65D 27/00; G11B 31/00

(52) U.S. Cl. 229/68.1; 369/68; G9B/31

(57) ABSTRACT

An envelope having a sound mechanism for storing a recorded or prerecorded audible signal or sound for playback upon opening the envelope, the sound mechanism including components of a sound circuit that are hidden within the back panel of the envelope and with an actuator provided to activate the sound upon the opening of the seal flap.

### BACKGROUND OF THE INVENTION

1. Field of the Invention

The present invention relates to the field of envelopes, and, more particularly, to an envelope that may record and/or produce an audible signal or message when actuated by opening.

2. Brief Description of the Related Art

Recordable greeting cards and pre-recorded greeting cards' are widely used. Generally, the greeting cards are designed to be activated by opening the cover. Many cards include a circuit that has one particular prerecorded message. A user selects among the cards in the store to choose the message desired. A card with a built-in record and playback capability is disclosed in U.S. Pat. No. 4,791,741 issued on Dec. 20, 1988 to Takenori Kondo. A card is provided where a user may record his or her own messages and have them played back by the recipient when the recipient opens the card. Often, cards are sent through the mail delivery service, such as, for example, a postal service. The card may be put through handling devices for sorting and transporting mail. That may cause pressure on the sound circuitry and components, and when the card reaches its ultimate destination, may no longer function. Another sound producing device is found in a magazine. A sound producing folding magazine insert is disclosed in U.S. patent application publication no. US2007/0151131. The magazine insert is designed to activate sound emitting means when the insert fold is opened. Re-recordable circuitry is disclosed in U.S. Pat. No. 5,387,108 issued on Feb. 7, 1995 to Christopher S. Cromwell, and the disclosure shows the circuitry with a pop-up greeting card.

Greeting cards are generally designed to be signed with a signature or note and sent to a recipient. With the popularity of personal printers many individuals prepare their own greeting cards. In addition, some stores have kiosks where cards may be designed and purchased. Many individuals also print their own invitations. In doing so, individuals may make customized choices and may design an invitation in a manner that is desired, including choosing the appearance of the design or pictures to appear thereon, the wording, the card stock, colors and other attributes.

A need exists for an improved device that may be used to communicate a sound message and provide the individual with the freedom to customize the card as well as the message or sound.

### SUMMARY OF THE INVENTION

My invention provides an envelope having a sound mechanism for storing a recorded or prerecorded audible signal or sound for playback upon opening the envelope. The sound mechanism may be a sound module that is hidden within the back panel of the envelope, and may be actuated upon the opening of the seal flap. According to preferred embodiments, the module may be hidden beneath a covering layer provided on the interior of the back panel of the envelope.

According to one embodiment, the sound module is provided with a prerecorded sound, such as, a spoken or sung greeting, music or other appropriate sounds (e.g., cheering).

According to an alternate embodiment, the sound module is provided with recordable circuitry for recording an audible sound for playback. The recordable circuitry preferably may include an erasable feature, so that a message may be re-recorded until the desired message is obtained. Also, the re-recordable circuitry feature, in some instances, may permit reuse of the envelope. For example, a customized recorded greeting may be made for each different guest, inviting them to an event with a personalized greeting.

The envelope is designed to be actuated when the seal flap is lifted apart from the lower flap. According to preferred embodiments, an actuation mechanism may be connected to the seal flap to actuate the sound module on the back panel of the envelope. Alternate embodiments may be configured with a light sensor activation mechanism.

Envelopes according to my invention may be provided in various shapes and sizes, and may be configured to accommodate mostly any card a consumer may purchase, as well as a customized or home-made card. Users may print their own invitations and cards or purchase any type of card, and customize the sound in the envelope.

These and other advantages are provided by my invention.

### BRIEF DESCRIPTION OF THE DRAWING FIGURES

FIG. 1 is a front elevation view of an envelope according to my invention.

FIG. 2 is rear elevation view of the envelope of FIG. 1.

FIG. 3 is a front elevation view of the envelope shown in FIG. 1 illustrated with the seal flap in a lifted position.

FIG. 4 is a front elevation view of the envelope of FIG. 1 shown in an expanded view with the sides and bottom flaps unfolded and detached, and with the sound module cover shown in broken-line representation.

### DETAILED DESCRIPTION OF THE PREFERRED EMBODIMENTS

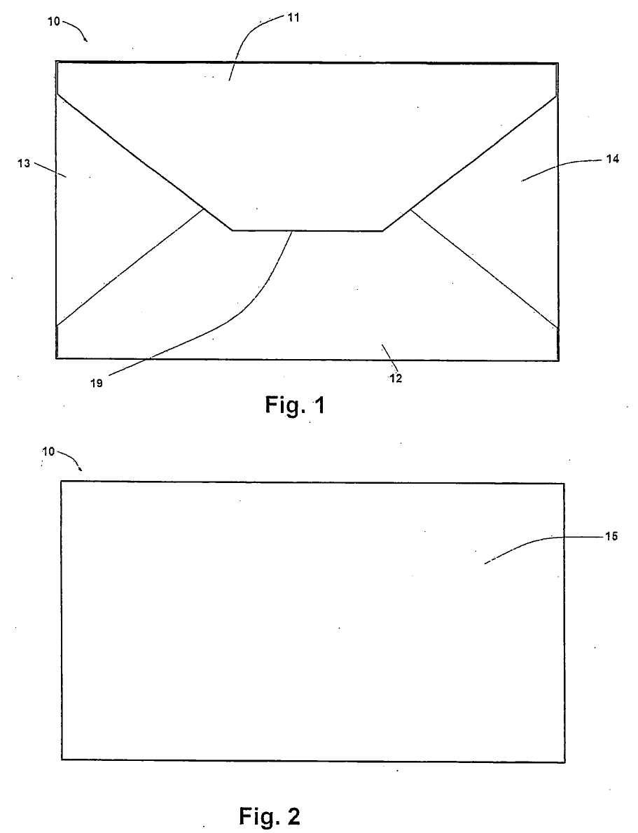

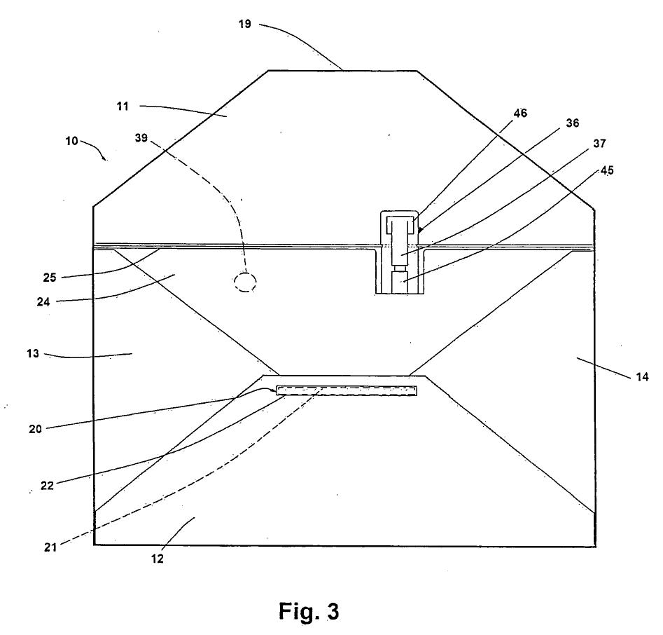

Referring to FIGS. 1 and 2, an envelope 10 with a recordable sound feature is illustrated. According to the exemplary embodiment illustrated the envelope 10 includes a top or seal flap 11, a bottom flap 12, a first side flap 13, a second side flap 14 and a back panel 15 (FIG. 2). The bottom flap 12 is shown overlapping each of the first side flap 13 and second side flap 14. Preferably, an adhesive component 15, 16 is provided to facilitate attachment of the edges 17, 18 of the first side flap 13 and second side flap 14, respectively. A seal flap closure preferably is provided, and may, for example, comprise a slot (not shown) to receive the seal tab end 19, or, as illustrated, may comprise an adhesive strip 20 including a layer of adhesive 21 and removable release paper 22 that covers the adhesive layer 21 and may be removed to expose the adhesive layer 21 so that the seal flap 11 may be attached to the bottom flap 12 (FIG. 3).

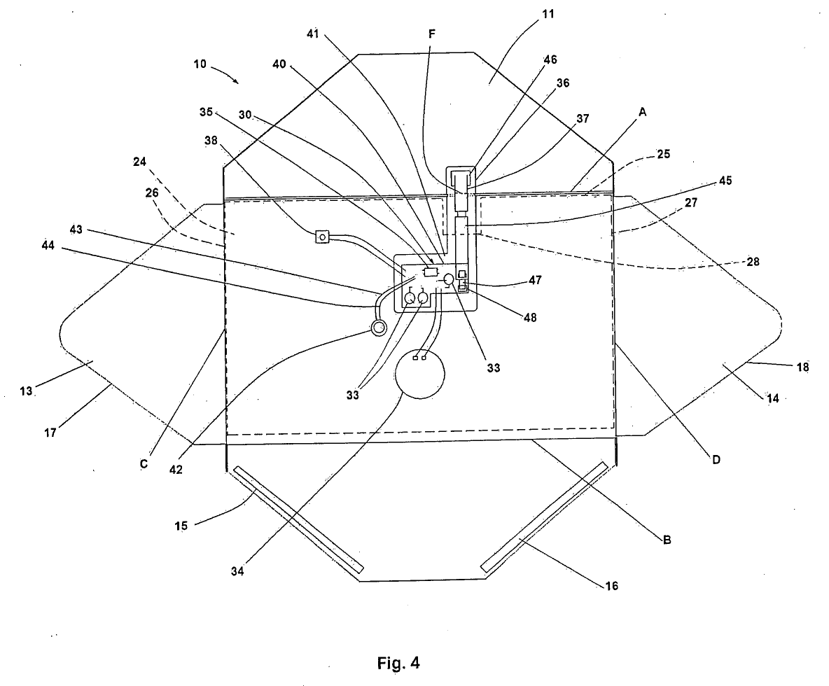

Referring to FIGS. 3 and 4, the envelope 10 is shown having a sound module 30 which is disposed on the interior of the back panel 15. A cover panel 24 is provided to conceal the circuitry and components of the sound module 30, as well as to provide protection for those components. The cover panel 24 preferably is attached at its top edge 25 to the inside of the back panel 15. Optionally, the cover panel 24 also may be attached along its side edges 26, 27 to the back panel 15. A suitable adhesive may be used to connect the cover panel 24 to the back panel 15. Preferably, the envelope 10 is constructed from paper, and more preferably, from card stock, though other materials may be used.

According to a preferred embodiment, the envelope 10 may be formed from a first panel which includes the back panel 15 and surrounding flaps (e.g., the seal flap 11, bottom flap 12 and first and second side flaps 13, 14, respectively), a cover panel 24 and a sound module 30. FIG. 4 illustrates the envelope 10 in an open condition with the bottom flap 12 and first side flap 13 and second side flap 14 detached and opened to expose the interior of the back panel 15 and the sound module 30. The cover panel 24, which would ordinarily cover the sound module 30, is shown in a broken-line representation so that the components of the sound module 30 may be shown and described. The fold lines A and B represent locations where the seal flap 11 and bottom flap 12 fold, respectively, relative to the back panel 15. Fold lines C and D represent locations where the first side flap 13 and second side flap 14 respectively, fold to cover the back panel 15. Preferably, the envelope 10 is scored in the locations where the first side flap 13 second side flap 14, bottom flap 12 and seal flap 11 join with the back panel 15 to facilitate folding and construction of the envelope 10.

As shown in FIG. 4, the sound module 30 preferably comprises a power source such as the batteries 33, a speaker 34 and a memory, such as, for example a memory chip 35 containing prerecorded sound, and an actuator mechanism 36 with an actuator 37. According to a preferred embodiment, an optional recording circuit may be included, and preferably includes a record button 38 to operate the recording feature. For example, the recording feature may be activated by depressing the record button 38, and holding the button 38 in a depressed position while recording an audible sound for playback when the actuator 37 is triggered. The sound module 30 includes a speaker 34 which is provided between the back panel 15 and the cover panel 24. The speaker 34 is provided to deliver the sound recording in an audible signal. The sound module 30 includes a circuit board 40 with circuitry provided thereon to connect and support components, such as, for example, the batteries 33, actuator mechanism 36 and memory chip 35. The sound module 30 may be provided on a self-adhesive backed support 41, which may be secured to the back panel 15 of the envelope, with a portion of the support 41 being disposed also on the seal flap 11. Release paper backing (not shown) may be provided to cover the adhesive of the support 41, which may be removed when the sound module 30 is to be applied to the envelope 10 components. A microphone 42 is provided and is connected with the circuitry, preferably, as shown, connects with wire leads 43, 44 on the circuit board 40.

The actuator mechanism 36 includes an actuator 37 which is configured as a tab portion 45 that is connected at one end to a base 46. Preferably, the actuator 37 may be constructed from a resilient material, such as, for example, plastic, and may function as a living spring whereupon it may be folded (e.g., along the fold line F (FIG. 4)) when the seal flap 11 is closed. The tab portion 45 connects with a terminal 47 of a switch mechanism 48 so that when the envelope seal flap 11 is closed (e.g., folded over the top), then the tab portion 45 breaks the circuit connection of the switch mechanism 48. Conversely, when the seal flap 11 is lifted to open the envelope 10, then the actuator 37 is withdrawn from its interfering position and the circuit is completed to permit activation of the sound playback (or sound recording if the recording button is depressed). As illustrated in FIG. 4, the actuator mechanism 36 includes a tab portion 45 that attaches to a connecting portion 46 that is located on the inside of the seal flap 11. When the seal flap 11 is closed (folded) the actuator tab portion 45 is moved into a position to switch the sound off.

Recording preferably is done by depressing the record button 38 when the seal flap 11 is opened (unfolded) and the sound mechanism is activated. According to a preferred embodiment, the circuit is configured so that a recording is made by depressing and holding the record button in its depressed position for the duration that one desires to record. When the record button 38 is released from its depressed position, the recording stops. Thereafter, opening of the envelope (e.g., lifting the seal flap) plays back the recording. The recording length may be any suitable length desired and may be determined by the circuitry and the memory provided. For example, according to a preferred embodiment, the recording time allocated for a person to record a message preferably may be provided to be from between about a few seconds to a few minutes. The circuitry may be configured to provide a desired recording time. Preferably, a recording that is made is erasable so that a number of recordings (or re-recordings) may be subsequently made. The record button 38 preferably functions to operate the erase recording feature of the circuit (for example, by permitting recording over a previous recording). The sound module preferably is configured so that the recorded message (song, or other audible signal) plays for the duration of the recording time each time the envelope seal flap is opened. The sound module may be configured so that when the envelope seal flap is closed the sound circuit is interrupted and the sound stops. According to alternate embodiments, prerecorded sound, such as, for example, preprogrammed messages, is provided. The alternate embodiments having prerecorded sound preferably provide a sound module which does not include a record button or a microphone. A variety of stock recordings may be provided from which to select. Preferably, as illustrated in the drawing figures, the sound module components, such as, for example, the microphone 42, record button 38 and speaker 34, remain hidden by the cover panel 24, which preferably, may comprise a layer of paper, such as card stock. The cover panel 24 in addition to maintaining the attractiveness of the envelope also serves to protect the sound module and components. The cover panel 24 preferably is installed to the back panel 15 with a suitable adhesive, such as, for example, glue, adhesive strips or the like. Preferably, the sound module 30 and actuator mechanism 36 may be installed on the interior of the back panel 15, and the cover panel 24 installed thereafter. According to preferred embodiments, the record button 38 preferably remains hidden beneath the cover panel 24. Preferably, indicia 39 is provided on the face of the cover panel 24 in the location overlaying the recording button 38. The indicia 39, for example, may be the word “record” or words “record/erase”, an image of a button, a design, or combinations of these. Preferably, an adhesion free zone is provided along the innermost edge 28 of the cover panel 24 to permit passage of the actuator 37 thereunder.

According to an alternate embodiment, the cover panel 24 may be constructed with an upper edge 25 which extends parallel to the fold line A, so that more of the actuator 37 remains concealed. Accordingly, where the cover panel embodiment includes a generally parallel top edge, preferably, a slot is formed between the back panel 15 and the cover panel 24 at a location near the actuation mechanism 36 to provide a space for the actuator 37 to pass through.

Preferably, the seal flap 11 includes a closure seal 20, as described above. According to one embodiment, the closure seal 20 may be an adhesive, such as, for example, double sided tape with release paper 22. According to an alternate embodiment, the seal flap 11 may be secured to the bottom flap 12 (as is shown in the closed position in FIG. 1) with alternate securing features, such as, for example, matingly associated surfaces of hooks and loops, such as Velcro®.

Preferred embodiments provide envelopes that may be dimensioned from about two by four inches to about ten by twelve inches, so that cards of those approximate dimensions may be held therein. Though preferred dimensions have been referred to, the envelope may have other dimensions, to handle other sizes and type of cards, invitations and the like, and may be constructed in accordance with the disclosure herein. Envelopes may be sized smaller or larger depending on the application and use for which they are intended. Preferably, the envelopes may be constructed from card stock, and preferably paper stock having a thickness of about 0.010 inches or 10 point (10 pt.). For embodiments where larger envelopes are constructed, the point size may be greater. Alternately, the envelope 10 may be constructed from materials which envelopes may be constructed, including, for example, paper, card stock, plastics, cardboard recycled materials and the like.

Though a record button 38 is shown, alternate recording activation mechanisms may be used, such as, for example, a pull-tab.

Preferably, the envelope 10 may be constructed by cutting the configuration of the envelope from card stock and making score lines in the locations where the sections join the back panel 15, as discussed herein. Preferably, the sound module 30 is installed on the back panel 15 and the actuation mechanism 36 installed, in part, on the inside of the seal flap 15. In the event that the speaker 34 is not included on the circuit board of the module 30 or is separate, then the speaker is adhered to the back panel 15. The microphone 42 preferably also is secured to the back panel 15 (if not part of the sound module circuit board), and the record button 38 preferably, is attached on the back panel about an inch or two on either side of the pull tab actuator 37. This arrangement is a preferred configuration. Once the sound module 30 is installed, then the cover panel 24 may be attached in place to cover the sound module 30 and circuit components.

According to a preferred embodiment, once the cover panel 24 is installed, the first side flap 13 and second side flap 14 are folded inwardly, toward the center, over the back panel 15 (and cover panel 24 thereon), and the bottom flap 12 is folded inwardly to seal with the side flaps 13, 14 to form the envelope 10. Suitable attachment means, such as, for example, double sided tape, glue or the like is used.

According to alternate embodiments, though not shown, the actuator mechanism 36 though shown comprising a pull tab actuator 37, may alternately comprise a light sensor that responds to light when the envelope seal flap 11 is opened or lifted.

The positioning of the sound module 30 and recording button 38 provides an attractive appearance and remains functional though, at the same time, is hidden and does not obstruct the attractiveness of the envelope. The sound module 30 preferably is constructed to have minimal thickness, and may include button or flat cell batteries as a power source to further facilitate minimizing the thickness of the module.

While the invention has been described with reference to specific embodiments, the description is illustrative and is not to be construed as limiting the scope of the invention. Various modifications and changes may occur to those skilled in the art without departing from the spirit and scope of the invention described herein and as defined by the appended claims.

What is claimed is:

1. An envelope with an audible signal feature, comprising:
a) a panel constructed from material configured to be folded to form an envelope;
b) a sound module with sound circuitry to generate an audible signal;
c) wherein said sound module includes an actuator arranged to operate to correspond with the opening and closing of said envelope to respectively produce an audible signal.

2. The envelope of claim 1, wherein said envelope has an opening communicating with a space formed therein for holding one or more items therein, and wherein said envelope comprises a seal flap that is movable between a first position that covers said envelope opening and at least one other position that uncovers said envelope opening.

3. The envelope of claim 2, wherein said sound module includes recordable circuitry for recording and rerecording messages.

4. The envelope of claim 3, including a microphone and a switch to activate the recording circuitry to record from said microphone.

5. The envelope of claim 1, comprising a cover for covering said sound module.

6. The envelope of claim 4, comprising a cover for covering said sound module.

7. The envelope of claim 6, wherein said actuator comprises a pull tab attached to said seal flap to regulate activation of said sound circuitry to correspond with the position of seal flap.

8. The envelope of claim 6, wherein said actuator comprises a light sensor.

9. The envelope of claim 6, wherein said envelope is constructed from a sheet and includes a back panel with a top, first side, a second side, and a bottom; a seal flap connected to the top of said back panel; a first side flap connected to the first side of said back panel, a second side flap connected to the second side of said back panel, and a bottom flap connected to the bottom of said back panel, wherein said cover comprises a cover panel that is disposed over at least a portion of said back panel, and wherein said first side flap and said second side flap are inwardly folded with said bottom flap and are secured together.

10. The envelope of claim 5, wherein switch comprises a record button and wherein said cover is provided with indicia identifying the location of the record button.

11. The envelope of claim 1, including a power source.

12. The envelope of claim 11, wherein said sound module includes a circuit board.

13. The envelope of claim 1, including a closure for sealing the envelope.

14. The envelope of claim 2, including a closure for securing said seal flap over said envelope opening.

15. The envelope of claim 14, wherein said closure comprises an adhesive strip with a release paper covering.

16. The envelope of claim 14, wherein said closure comprises mating surfaces of hooks and loops.

17. An envelope with an audible signal feature, comprising:
a) a back panel,
b) a seal flap,
c) a first side flap,
d) a second side flap,
e) a bottom flap,
f) a first adhesive layer securing said bottom flap with said first side flap;
g) a second adhesive layer securing said bottom flap with said second side flap;
h) a sound module including a sound producing circuit with a speaker, a power source and a sound storage media;
i) an actuator connected with the sound module to activate the operation of the sound module to produce an audible signal through the speaker;
j) wherein the first side flap and second side flap are folded inward over a portion of said back panel;
k) wherein said bottom panel is folded inward over said back panel and over at least a portion of each said first side flap and said second side flap;
l) an adhesive layer attaching said sound module to the back panel;
m) a cover panel attached to said back panel and covering said sound module, said cover panel having at least one edge that is not attached to said back panel and which forms an actuator opening defined by said back panel and said cover panel, said actuator opening being dimensioned to permit said actuator to pass therethrough;
n) a switch for regulating the operation of said sound producing circuit;
n) wherein said actuator has a first end connected to said seal flap and a second end connected to said switch, and wherein said actuator is moveable within said actuator opening to be inserted into and withdrawn from said switch.

18. An envelope with an audible signal and recording features, comprising:
a) a back panel,
b) a seal flap,
c) a first side flap,
d) a second side flap,
e) a bottom flap,
f) a first adhesive layer securing said bottom flap with said first side flap;
g) a second adhesive layer securing said bottom flap with said second side flap;
h) a sound module including a sound producing circuit with a speaker, a power source and a sound storage media;
i) an actuator connected with the sound module to activate the operation of the sound module to produce an audible signal through the speaker;
j) wherein the first side flap and second side flap are folded inward over a portion of said back panel;
k) wherein said bottom panel is folded inward over said back panel and over at least a portion of each said first side flap and said second side flap;
l) an adhesive layer attaching said sound module to the back panel;
m) a cover panel attached to said back panel and covering said sound module, said cover panel having at least one edge that is not attached to said back panel and which forms an actuator opening defined by said back panel and said cover panel, said actuator opening being dimensioned to permit said actuator to pass therethrough;
n) a switch for regulating the operation of said sound producing circuit;
n) wherein said actuator has a first end connected to said seal flap and a second end connected to said switch, and wherein said actuator is moveable within said actuator opening to be inserted into and withdrawn from said switch;
o) a microphone, said microphone being connected with said sound producing circuit and being disposed between said back panel and said cover panel;
p) a record button, said record button being connected with said sound producing circuit to control recording from said microphone, said record button being disposed between said back panel and said cover panel;
q) said cover panel including indicia in the location above said recording button to identify the location of the recording button;
r) wherein said sound producing circuit has storage media comprising a memory for storing recorded sound recorded with said microphone, and is configured to playback said recorded sound when said actuator is activated.

19. The envelope of claim 17, wherein said sound module includes an adhesive backing, and wherein said adhesive backing is provided to attach said actuator to at least the back panel and said seal flap of said envelope.

20. The envelope of claim 17, wherein said cover panel comprises an protective member to protect said sound module.
